(19) United States
(12) Patent Application Publication
(10) Pub. No.: US 2024/0413555 A1
(43) Pub. Date: Dec. 12, 2024

(54) ELECTRICAL CONNECTOR AND CONNECTION STRUCTURE

(71) Applicant: SUMITOMO ELECTRIC INDUSTRIES, LTD., Osaka (JP)

(72) Inventor: Yasunori ASANO, Osaka-shi (JP)

(73) Assignee: SUMITOMO ELECTRIC INDUSTRIES, LTD., Osaka (JP)

(21) Appl. No.: 18/625,465

(22) Filed: Apr. 3, 2024

(30) Foreign Application Priority Data
Jun. 7, 2023 (JP) 2023-093970

(51) Int. Cl. H01R 12/77; H01R 13/46; H01R 13/6589

(52) U.S. Cl. CPC H01R 12/771; H01R 13/46; H01R 13/6589

(57) ABSTRACT

An electrical connector includes a ferrule, a plurality of electric wires, and a conductor. The ferrule includes a front-end surface and a plurality of insertion holes extending along a first direction intersecting the front-end surface, the plurality of insertion holes being open in the front-end surface. The plurality of electric wires are disposed in the plurality of insertion holes. The conductor is provided on the ferrule. The ferrule includes a groove formed at least between a pair of insertion holes adjacent to each other among the plurality of insertion holes. The conductor includes a body portion disposed in the groove and a protruding portion protruding from the front-end surface in the first direction, the protruding portion being elastically deformable in the first direction.

### TECHNICAL FIELD

The present disclosure relates to an electrical connector and a connection structure. The present application claims priority based on Japanese Patent Application No. 2023-093970 filed on Jun. 7, 2023, the entire contents of which are incorporated herein by reference.

### BACKGROUND OF THE INVENTION

Japanese Unexamined Patent Publication No. 2021-96933 describes an electrical connector including a housing, a plurality of terminals provided inside the housing, and a shield disposed outside the housing. In the electrical connector described in Japanese Unexamined Patent Publication No. 2021-96933, the shield is electrically connected to the ground pad of a mating connector, thereby reducing noise.

### SUMMARY OF THE INVENTION

An electrical connector of the present disclosure includes a ferrule including a front-end surface and a plurality of insertion holes extending along a first direction intersecting the front-end surface, the plurality of insertion holes being open in the front-end surface, a plurality of electric wires disposed in the plurality of insertion holes, and a conductor provided on the ferrule, wherein the ferrule includes a groove formed at least between a pair of insertion holes adjacent to each other among the plurality of insertion holes, and the conductor includes a body portion disposed in the groove and a protruding portion protruding from the front-end surface in the first direction, the protruding portion being elastically deformable in the first direction.

### BRIEF DESCRIPTION OF THE DRAWINGS

FIG. 1 is a front view of a connection structure according to an embodiment;

FIG. 2 is a plan view of an electrical connector illustrated in FIG. 1;

FIG. 3 is a partially enlarged view of the electrical connector illustrated in FIG. 1;

FIG. 4 is a sectional view of the electrical connector taken along the line IV-IV illustrated in FIG. 3;

FIG. 5 is a sectional view of the electrical connector taken along the line V-V illustrated in FIG. 3;

FIG. 6 is a sectional view of the connection structure illustrated in FIG. 1; and

FIG. 7 is a sectional view of a connection structure according to a modification.

### DETAILED DESCRIPTION

### Problems to be Solved by Present Disclosure

In the electric connector described in Japanese Unexamined Patent Publication No. 2021-96933, the plurality of terminals are provided inside the housing, whereas the shield is disposed outside the housing, and thus noise reduction is limited.

### Effects of Present Disclosure

According to the present disclosure, it is possible to provide an electrical connector and a connection structure capable of achieving noise reduction.

### DESCRIPTION OF EMBODIMENTS OF PRESENT DISCLOSURE

First, contents of embodiments of the present disclosure will be listed and described.

An electrical connector of the present disclosure is [1] “an electrical connector including a ferrule including a front-end surface and a plurality of insertion holes extending along a first direction intersecting the front-end surface, the plurality of insertion holes being open in the front-end surface, a plurality of electric wires disposed in the plurality of insertion holes, and a conductor provided on the ferrule, wherein the ferrule includes a groove formed at least between a pair of insertion holes adjacent to each other among the plurality of insertion holes, and the conductor includes a body portion disposed in the groove and a protruding portion protruding from the front-end surface in the first direction, the protruding portion being elastically deformable in the first direction”.

In the electrical connector according to [1], the conductor includes a body portion located at least between a pair of insertion holes adjacent to each other. This makes it possible to realize the proximity of the conductor to the electric wire disposed in the insertion hole as compared with a case where the conductor is disposed outside the ferrule, for example. Thus, noise reduction can be realized. Moreover, the conductor includes the protruding portion that protrudes from the front-end surface and is elastically deformable. This makes it possible to suitably connect the body portion to the ground electrode by bringing the protruding portion into contact with the ground electrode of the mating connector disposed so as to face the front-end surface, which can contribute to noise reduction. Thus, according to this electrical connector, noise reduction can be realized.

The electrical connector of the present disclosure may be [2] “the electrical connector according to [1], wherein the plurality of insertion holes are constituted by a first insertion hole array arranged along a second direction when viewed from the first direction and a second insertion hole array located adjacent to the first insertion hole array in a third direction intersecting the second direction when viewed from the first direction and arranged along the second direction, the groove includes a first groove region located between the first insertion hole array and the second insertion hole array and extending along the second direction when viewed from the first direction, a second groove region located at least between a pair of insertion holes adjacent to each other in the first insertion hole array, and a third groove region located at least between a pair of insertion holes adjacent to each other in the second insertion hole array, the body portion includes a first body region disposed in the first groove region, a second body region disposed in the second groove region, and a third body region disposed in the third groove region, and the protruding portion protrudes from each of the first body region, the second body region, and the third body region”. This makes it possible to realize the proximity of the conductor to each of the plurality of electric wires disposed in the plurality of insertion holes, which can more efficiently reduce noise.

The electrical connector of the present disclosure may be [3] “the electrical connector according to [1] or [2], wherein the protruding portion includes a first elastic body protruding from the body portion and a second elastic body protruding from the body portion, and the first elastic body and the second elastic body are disposed to cross each other”. As a result, even when the first elastic body does not come into contact with the ground electrode of the mating connector, the second elastic body comes into contact with the ground electrode, and thus the protruding portion can be certainly brought into contact with the ground electrode.

The electrical connector of the present disclosure may be [4] “the electrical connector according to any one of [1] to [3], wherein the conductor is integrally formed by one plate-shaped member”. As a result, for example, as compared with a case where the conductor is formed of a plurality of plate-shaped members connected by welding or the like, the distribution of the thermal expansion coefficient of the conductor becomes uniform, and thus the reliability of the conductor is improved.

The electrical connector of the present disclosure may be [5] “the electrical connector according to any one of [1] to [4], wherein a surface of the protruding portion is plated”. This improves reliability of electrical connection of the protruding portion to the ground electrode of the mating connector.

The electrical connector of the present disclosure may be [6] “the electrical connector according to any one of [1] to [5], wherein the plurality of electric wires are a plurality of electric wires of a flexible flat cable”. This makes is possible to reduce noise of the plurality of electric wires of the flexible flat cable.

A connection structure of the present disclosure is [7] “a connection structure including the electrical connector according to any one of [1] to [6], and a mating connector including a substrate and a ground electrode provided on a main surface of the substrate, wherein the electrical connector is connected to the mating connector with the front-end surface facing the main surface, and the protruding portion is in contact with the ground electrode in an elastically deformed state”.

The connection structure according to [7] can realize noise reduction as described above. In addition, since the protruding portion is in contact with the ground electrode of the mating connector in an elastically deformed state, the protruding portion can be certainly brought into contact with the ground electrode.

The connection structure of the present disclosure may be [8] “the connection structure according to [7], wherein the substrate includes a protruding surface protruding from the main surface and abutting on the ferrule of the electrical connector”. This makes it possible to certainly fix the ferrule to the mating connector while certainly bringing the protruding portion into contact with the ground electrode of the mating connector.

The connection structure of the present disclosure may be [9] “the connection structure according to [7], wherein the ferrule further includes an abutment surface protruding from the front-end surface and abutting on the substrate of the mating connector, and the abutment surface is located between a tip of the protruding portion and the front-end surface in the first direction”. This makes it possible to certainly fix the ferrule to the mating connector while certainly bringing the protruding portion into contact with the ground electrode of the mating connector.

### DETAILS OF EMBODIMENTS OF PRESENT DISCLOSURE

A specific example of the connector structure of the present disclosure will be described below with reference to the drawings. The present disclosure is not limited to these examples, but is indicated by the claims, and is intended to include all modifications within the meaning and scope equivalent to the claims. In the description of the drawings, the same elements are denoted by the same reference signs, and redundant description will be omitted.

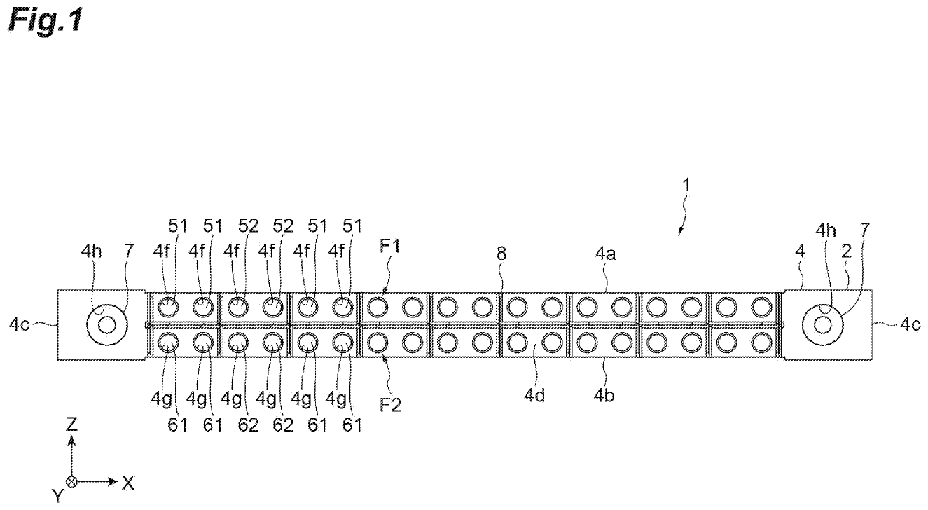

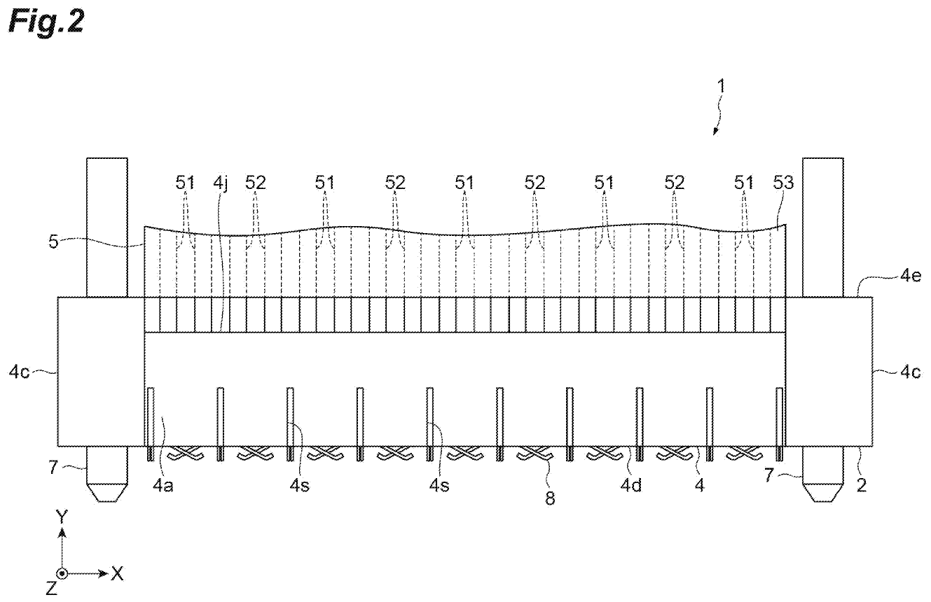

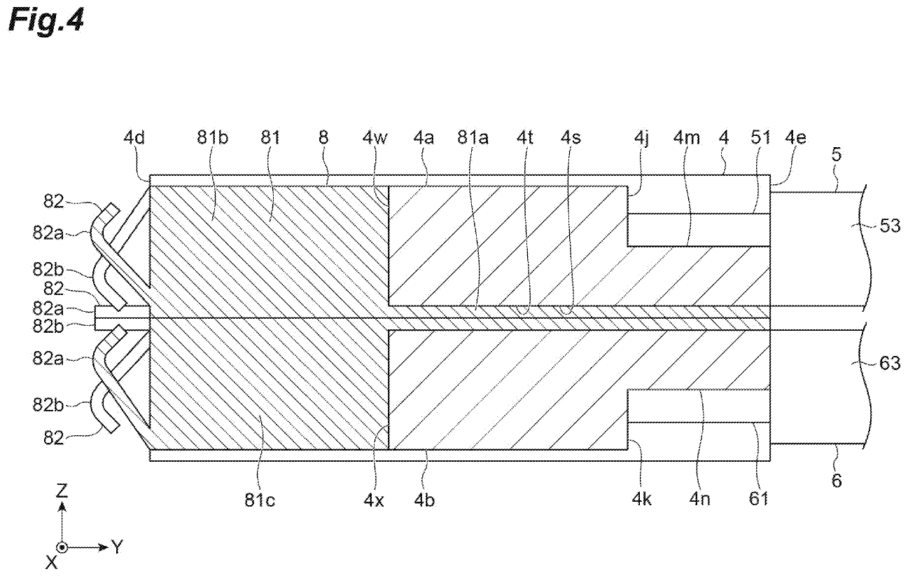

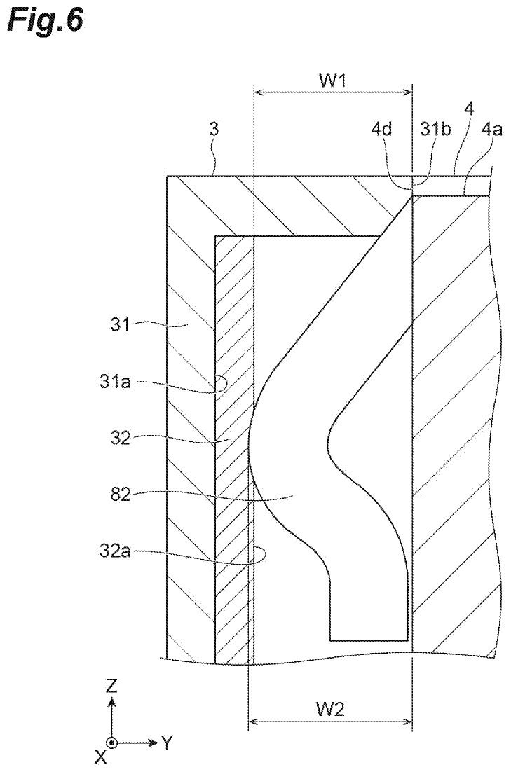

FIG. 1 is a front view of a connection structure according to the present embodiment. FIG. 2 is a plan view of an electrical connector illustrated in FIG. 1. As illustrated in FIGS. 1 and 2, a connection structure 1 includes an electrical connector 2 and a mating connector 3 (see FIG. 6). The electrical connector 2 includes a ferrule 4, a first cable 5, a second cable 6 (see FIG. 4), a pair of positioning pins 7, and a conductor 8.

The ferrule 4 includes a first main surface 4a, a second main surface 4b, a pair of side surfaces 4c, a front-end surface 4d, and a rear-end surface 4e. Each of the first main surface 4a and the second main surface 4b is a flat surface intersecting a Z-axis direction. The second main surface 4b faces the side opposite to the first main surface 4a. The side surface 4c is a flat surface intersecting an X-axis direction. The pair of side surfaces 4c face opposite sides to each other. Each of the front-end surface 4d and the rear-end surface 4e is a flat surface intersecting a Y-axis direction (first direction). The rear-end surface 4e faces the side opposite to the front-end surface 4d.

The ferrule 4 includes a first insertion hole array F1 and a second insertion hole array F2. The first insertion hole array F1 includes a plurality of insertion holes 4f arranged along the X-axis direction (second direction intersecting the first direction) when viewed from the Y-axis direction. The insertion hole 4f extends along the Y-axis direction and is open in each of the front-end surface 21d and the rear-end surface 21e. The second insertion hole array F2 is located adjacent to the first insertion hole array F1 in the Z-axis direction (third direction intersecting both the first direction and the second direction) when viewed from the Y-axis direction. The second insertion hole array F2 includes a plurality of insertion holes 4g arranged along the X-axis direction when viewed from the Y-axis direction. The insertion hole 4g extends along the Y-axis direction and is open in each of the front-end surface 21d and the rear-end surface 21e. In this manner, the plurality of insertion holes 4f and the plurality of insertion holes 4g of the ferrule 4 are constituted by the first insertion hole array F1 and the second insertion hole array F2.

The ferrule 4 includes a pair of through holes 4h. The pair of through holes 4h are located on both sides of the plurality of insertion holes 4f and the plurality of insertion holes 4g in the X-axis direction when viewed from the Y-axis direction. The through hole 4h penetrates the ferrule 4 in the Y-axis direction and is open in each of the front-end surface 4d and the rear-end surface 4e.

Each positioning pin 7 is inserted into the corresponding through hole 4h. In the present embodiment, the positioning pin 7 is press-fitted into the through hole 4h, for example. The front end of the positioning pin 7 protrudes from the front-end surface 4d of the ferrule 4. The rear end of the positioning pin 7 protrudes from the rear-end surface 4e of the ferrule 4. The ferrule 4 is positioned with respect to the mating connector 3 by the pair of positioning pins 7. Specifically, the ferrule 4 is connected to the mating connector 3 such that the positioning pin 7 is inserted into a positioning hole of the mating connector 3.

The first cable 5 is, for example, a flexible flat cable (FFC). The first cable 5 includes a plurality of electric wires 51, a plurality of electric wires 52, and a cover 53. In the present embodiment, two electric wires 51 adjacent to each other and two electric wires 52 adjacent to each other are alternately arranged along the X-axis direction. The cover 53 bundles the plurality of electric wires 51 and the plurality of electric wires 52. Tip portions of the electric wire 51 and the electric wire 52 are arranged in the insertion hole 4f in a state of being exposed from the cover 53. Tips of the electric wire 51 and the electric wire 52 reach the front-end surface 4d of the ferrule 4. The electric wire 51 functions as, for example, a working electrode. The electric wire 52 functions as, for example, a ground electrode.

Similarly to the first cable 5, the second cable 6 (see FIG. 4) is, for example, a flexible flat cable (FFC). The second cable 6 includes a plurality of electric wires 61, a plurality of electric wires 62, and a cover 63 (see FIG. 4). In the present embodiment, two electric wires 61 adjacent to each other and two electric wires 62 adjacent to each other are alternately arranged along the X-axis direction. Two electric wires 51 of the first cable 5 and two electric wires 61 of the second cable 6 are arranged along the Z-axis direction. Two electric wires 52 of the first cable 5 and two electric wires 62 of the second cable 6 are arranged along the Z-axis direction. The cover 63 bundles the plurality of electric wires 61 and the plurality of electric wires 62. Tip portions of the electric wire 61 and the electric wire 62 are arranged in the insertion hole 4g in a state of being exposed from the cover 63. Tips of the electric wire 61 and the electric wire 62 reach the front-end surface 4d of the ferrule 4. The electric wire 61 functions as, for example, a ground electrode. The electric wire 62 functions as, for example, a working electrode.

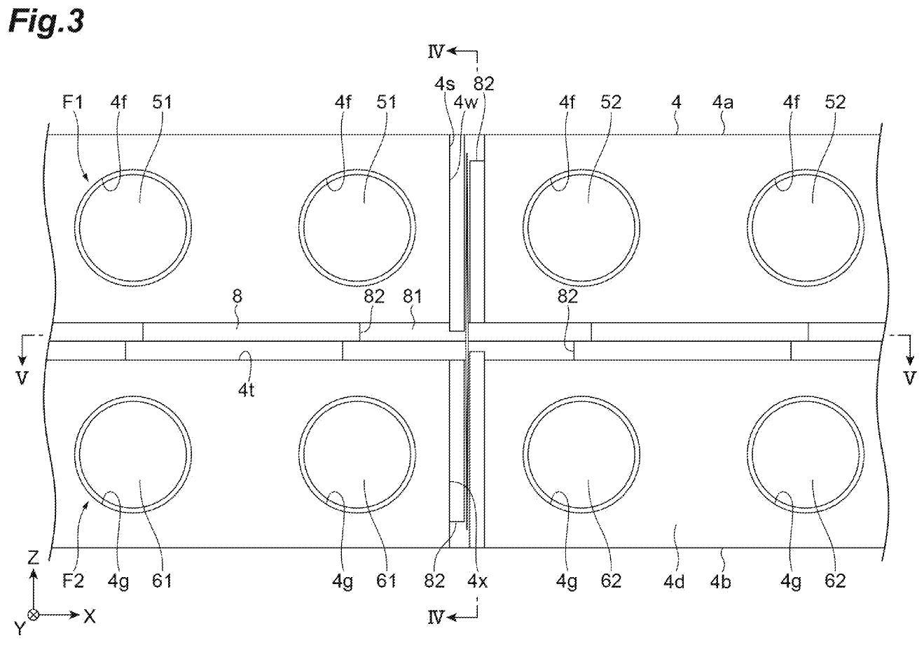

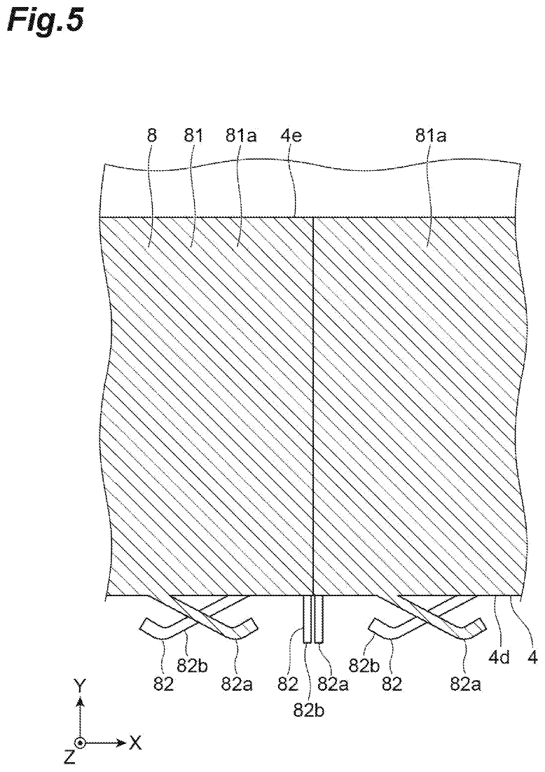

FIG. 3 is a partially enlarged view of the electrical connector 2 illustrated in FIG. 1. FIG. 4 is a sectional view of the electrical connector 2 taken along the line IV-IV illustrated in FIG. 3. FIG. 5 is a sectional view of the electrical connector 2 taken along the line V-V illustrated in FIG. 3.

As illustrated in FIGS. 3 to 5, the ferrule 4 includes a groove 4s. The groove 4s is formed at least between a pair of insertion holes adjacent to each other among the plurality of insertion holes 4f and the plurality of insertion holes 4g. The groove 4s includes a first groove region 4t, a plurality of second groove regions 4w, and a plurality of third groove regions 4x.

The first groove region 4t is located between the first insertion hole array F1 and the second insertion hole array F2 when viewed from the Y-axis direction. The first groove region 4t extends along the X-axis direction. Both ends of the first groove region 4t in the X-axis direction are located outside both ends of the first insertion hole array F1 in the X-axis direction and both ends of the second insertion hole array F2 in the X-axis direction. The first groove region 4t is open in each of the front-end surface 4d and the rear-end surface 4e. The first groove region 4t does not reach the pair of side surfaces 4c.

The second groove region 4w is located at least between a pair of insertion holes 4f adjacent to each other in the first insertion hole array F1. In the present embodiment, each second groove region 4w is formed between two insertion holes 4f in which two electric wires 51 are disposed and another two insertion holes 4f in which two electric wires 52 adjacent to the two electric wires 51 are disposed, and on both sides of the first insertion hole array F1 in the X-axis direction. The second groove region 4w communicates with the first groove region 4t. The second groove region 4w is open in each of the front-end surface 4d and the first main surface 4a. The second groove region 4w does not reach the rear-end surface 4e.

The third groove region 4x is located at least between a pair of insertion holes 4g adjacent to each other in the second insertion hole array F2. In the present embodiment, each third groove region 4x is formed between two insertion holes 4g in which two electric wires 61 are disposed and another two insertion holes 4g in which two electric wires 62 adjacent to the two electric wires 61 are disposed, and on both sides of the second insertion hole array F2 in the X-axis direction. The third groove region 4x communicates with the first groove region 4t. The third groove region 4x is open in each of the front-end surface 4d and the second main surface 4b. The third groove region 4x does not reach the rear-end surface 4e. The ferrule 4 is symmetrical with respect to a center line parallel to the Z-axis direction and a center line parallel to the X-axis direction when viewed from the Y-axis direction.

The conductor 8 is provided on the ferrule 4. The conductor 8 includes a body portion 81 and a plurality of protruding portion 82. Each of the body portion 81 and the protruding portion 82 is a partial region of the conductor integrally formed of the same material. The material of the conductor 8 is, for example, copper (Cu). The body portion 81 is disposed in the groove 4s. Specifically, the body portion 81 includes a first body region 81a, a second body region 81b, and a third body region 81c.

The first body region 81a is disposed in the first groove region 4t. The first body region 81a has, for example, a plate shape. Both ends of the first body region 81a in the X-axis direction reach both ends of the first insertion hole array F1 in the X-axis direction and both ends of the second insertion hole array F2 in the X-axis direction. One end of the first body region 81a in the Y-axis direction reaches the front-end surface 4d. The other end of the first body region 81a in the Y-axis direction reaches the rear-end surface 4e. When viewed from the Z-axis direction, the first body region 81a overlaps the first insertion hole array F1 and the second insertion hole array F2.

The second body region 81b is disposed in the second groove region 4w. The second body region 81b has, for example, a plate shape. The distal end of the second body region 81b in the Z-axis direction reaches the first main surface 4a. The proximal end of the second body region 81b in the Z-axis direction is connected to the first body region 81a. One end of the second body region 81b in the Y-axis direction reaches the front-end surface 4d. The other end of the second body region 81b in the Y-axis direction does not reach the rear-end surface 4e. When viewed from the X-axis direction, the second body region 81b overlaps the insertion hole 4f.

The third body region 81c is disposed in the third groove region 4x. The third body region 81c has, for example, a plate shape. The distal end of the third body region 81c in the Z-axis direction reaches the second main surface 4b. The proximal end of the third body region 81c in the Z-axis direction is connected to the first body region 81a. One end of the third body region 81c in the Y-axis direction reaches the front-end surface 4d. The other end of the third body region 81c in the Y-axis direction does not reach the rear-end surface 4e. When viewed from the X-axis direction, the third body region 81c overlaps the insertion hole 4g.

The plurality of protruding portions 82 protrude from the front-end surface 4d of the ferrule 4 in the Y-axis direction. When viewed from the X-axis direction or the Z-axis direction, the plurality of protruding portions 82 are located on the side opposite to the rear-end surface 4e with respect to the front-end surface 4d. The protruding portion 82 is formed between each of the second body regions 81b in the first body region 81a. These protruding portions 82 protrude from the distal end of the first body region 81a. The protruding portion 82 is formed at the distal end of each second body region 81b. These protruding portions 82 protrude from the distal end of the second body region 81b. The protruding portion 82 is formed at the distal end of each third body region 81c. These protruding portions 82 protrude from the distal end of the third body region 81c. In this manner, the plurality of protruding portions 82 are uniformly distributed around the insertion holes 4f and 4g when viewed from the Y-axis direction.

The protruding portion 82 is elastically deformable in the Y-axis direction. Specifically, the protruding portion 82 includes a first elastic body 82a and a second elastic body 82b. Each of the first elastic body 82a and the second elastic body 82b protrudes from the body portion 81. The proximal end of each of the first elastic body 82a and the second elastic body 82b is connected to the body portion 81. The distal ends of the first elastic body 82a and the second elastic body 82b are convexly curved in the same direction as the front-end surface 4d.

As illustrated in FIG. 5, the first elastic body 82a and the second elastic body 82b of the protruding portion 82 formed at the distal end of the first body region 81a are disposed so as to cross each other when viewed from the Z-axis direction. When viewed from the Y-axis direction, the first elastic body 82a and the second elastic body 82b are arranged along the Z-axis direction. When viewed from the Z-axis direction, the proximal end of the first elastic body 82a and the proximal end of the second elastic body 82b are separated from each other in the X-axis direction. When viewed from the Z-axis direction, the distal end of the first elastic body 82a and the distal end of the second elastic body 82b are separated from each other in the X-axis direction. When viewed from the Z-axis direction, the first elastic body 82a is inclined toward one end of the ferrule in the X-axis direction with increasing distance from the front-end surface 4d. When viewed from the Z-axis direction, the second elastic body 82b is inclined toward the other end of the ferrule in the X-axis direction with increasing distance from the front-end surface 4d. When viewed from the Z-axis direction, a part of the first elastic body 82a and a part of the second elastic body 82b overlap each other.

As illustrated in FIG. 4, the first elastic body 82a and the second elastic body 82b of the protruding portion 82 formed at the distal end of the second body region 81b are disposed so as to cross each other when viewed from the X-axis direction. When viewed from the X-axis direction, the proximal end of the first elastic body 82a and the proximal end of the second elastic body 82b are separated from each other in the Z-axis direction. When viewed from the X-axis direction, the distal end of the first elastic body 82a and the distal end of the second elastic body 82b are separated from each other in the Z-axis direction. When viewed from the X-axis direction, the first elastic body 82a is inclined toward one end of the ferrule in the Z-axis direction with increasing distance from the front-end surface 4d. When viewed from the X-axis direction, the second elastic body 82b is inclined toward the other end of the ferrule in the Z-axis direction with increasing distance from the front-end surface 4d. When viewed from the X-axis direction, a part of the first elastic body 82a and a part of the second elastic body 82b overlap each other. The first elastic body 82a and the second elastic body 82b of the protruding portion 82 formed at the distal end of the third body region 81c are also disposed so as to cross each other when viewed from the X-axis direction, in the same manner as the first elastic body 82a and the second elastic body 82b of the protruding portion 82 formed at the distal end of the second body region 81b.

When receiving a load along the Y-axis direction, the first elastic body 82a and the second elastic body 82b are elastically deformed in the Y-axis direction. The surfaces of the first elastic body 82a and the second elastic body 82b are plated with, for example, gold, tin, or the like.

The conductor 8 is integrally formed by one plate-shaped member. The conductor 8 is formed by bending one plate-shaped member. When the conductor 8 is taken out from the groove 4s and then extended, the conductor 8 becomes one plate-shaped member. The conductor 8 includes a plurality of plate-shaped regions. In the first body region 81a of the body portion 81, a region located between two insertion holes 4f and two insertion holes 4g is constituted by two plate-shaped regions stacked on each other. The second body region 81b of the body portion 81 is constituted by two plate-shaped regions stacked in a state of being connected to each other. The third body region 81c of the body portion 81 is constituted by two plate-shaped regions stacked in a state of being connected to each other. The first elastic body 82a or the second elastic body 82b of the protruding portion 82 is formed in each of the plate-shaped regions described above. Each first elastic body 82a and each second elastic body 82b is formed by punching one plate-shaped member.

As illustrated in FIG. 4, the ferrule 4 includes a first disposition surface 4m and a second disposition surface 4n. Each of the first disposition surface 4m and the second disposition surface 4n is a flat surface intersecting the Z-axis direction. The first disposition surface 4m faces the same direction as the first main surface 4a, and is recessed more than the first main surface 4a. The first disposition surface 4m and the first main surface 4a are connected by a first connection surface 4j. The first connection surface 4j is a flat surface intersecting the Y-axis direction. The insertion holes 4f of the first insertion hole array F1 are open toward the same direction as the first disposition surface 4m on the first disposition surface 4m. That is, in the first disposition surface 4m, the insertion hole 4f is a groove. In this case, the electric wire 51 and the electric wire 52 can be guided to the front-end surface 4d in a state of being disposed in the insertion hole 4f (groove) in the first disposition surface 4m.

The second disposition surface 4n faces the same direction as the second main surface 4b, and is recessed more than the second main surface 4b. The second disposition surface 4n and the second main surface 4b are connected by a second connection surface 4k. The second connection surface 4k is a flat surface intersecting the Y-axis direction. The insertion holes 4g of the second insertion hole array F2 are open toward the same direction as the second disposition surface 4n on the second disposition surface 4n. That is, in the second disposition surface 4n, the insertion hole 4g is a groove. In this case, the electric wire 61 and the electric wire 62 can be guided to the front-end surface 4d in a state of being disposed in the insertion hole 4g (groove) in the second disposition surface 4n.

FIG. 6 is a sectional view of the connection structure 1 illustrated in FIG. 1. As illustrated in FIG. 6, the mating connector 3 includes a substrate 31 and a ground electrode 32. The substrate 31 includes a main surface 31a and a protruding surface 31b. Each of the main surface 31a and the protruding surface 31b is a flat surface intersecting the Y-axis direction. Each of the main surface 31a and the protruding surface 31b faces the front-end surface 4d of the ferrule 4. The protruding surface 31b faces the same direction as the main surface 31a. The protruding surface 31b protrudes from the main surface 31a in the Y-axis direction. The protruding surface 31b abuts on the front-end surface 4d of the ferrule 4.

The ground electrode 32 is provided on the main surface 31a. A surface 32a of the ground electrode 32 is located between the main surface 31a and the protruding surface 31b in the Y-axis direction. A distance W1 between the protruding surface 31b and the surface 32a in the Y-axis direction is smaller than a natural length W2 of the protruding portion 82 in the Y-axis direction. The natural length W2 of the protruding portion 82 is a distance between a tip of the protruding portion 82 and the front-end surface 4d in the Y-axis direction in a state where the protruding portion 82 is not elastically deformed.

The electrical connector 2 is connected to the mating connector 3 such that the front-end surface 4d faces the main surface 31a. The front-end surface 4d of the electrical connector 2 and the protruding surface 31b of the mating connector 3 abut on each other. When the front-end surface 4d and the protruding surface 31b abut on each other, the protruding portion 82 comes into contact with the surface 32a of the ground electrode 32 in an elastically deformed state. This causes the conductor 8 of the electrical connector 2 to be electrically connected to the ground electrode 32 of the mating connector 3.

As described above, in the electrical connector 2, the conductor 8 includes the body portion 81 disposed between the first insertion hole array F1 and the second insertion hole array F2, between the insertion holes 4f adjacent to each other, and between the insertion holes 4g adjacent to each other. This makes it possible to realize the proximity of the conductor 8 to the electric wires 51 and 52 disposed in each insertion hole 4f and the electric wires 61 and 62 disposed in each insertion hole 4g as compared with a case where the conductor is disposed outside the ferrule, for example. Thus, noise reduction can be realized. Moreover, the conductor 8 includes the protruding portion 82 that protrudes from the front-end surface 4d and is elastically deformable. This makes it possible to suitably connect the body portion 81 to the ground electrode 32 by bringing the protruding portion 82 into contact with the ground electrode 32 of the mating connector 3 disposed so as to face the front-end surface 4d, which can contribute to noise reduction. Thus, according to the electrical connector 2, noise reduction can be realized.

The plurality of insertion holes 4f are constituted by the first insertion hole array F1 arranged along the X-axis direction when viewed from the Y-axis direction, and the plurality of insertion holes 4g are constituted by the second insertion hole array F2 located adjacent to the first insertion hole array F1 in the Z-axis direction and arranged along the X-axis direction when viewed from the Y-axis direction. The groove 4s includes the first groove region 4t located between the first insertion hole array F1 and the second insertion hole array F2 and extending along the X-axis direction when viewed from the Y-axis direction, the second groove region 4w located between two insertion holes 4f of the first insertion hole array F1 and another two insertion holes 4f adjacent to the two insertion holes 4f, and the third groove region 4x located between two insertion holes 4g of the second insertion hole array F2 and another two insertion holes 4g adjacent to the two insertion holes 4g. The body portion 81 includes the first body region 81a disposed in the first groove region 4t, the second body region 81b disposed in the second groove region 4w, and the third body region 81c disposed in the third groove region 4x. Each protruding portion 82 protrudes from the first body region 81a, the second body region 81b, and the third body region 81c. This makes it possible to realize the proximity of the conductor 8 to the electric wires 51 and 52 disposed in each insertion hole 4f and the electric wires 61 and 62 disposed in each insertion hole 4g, which can more efficiently reduce noise.

The protruding portion 82 includes the first elastic body 82a protruding from the body portion 81 and the second elastic body 82b protruding from the body portion 81. The first elastic body 82a and the second elastic body 82b are disposed so as to cross each other. As a result, even when the first elastic body 82a does not come into contact with the ground electrode 32 of the mating connector 3, the second elastic body 82b comes into contact with the ground electrode 32, and thus the protruding portion 82 can be certainly brought into contact with the ground electrode 32.

The conductor 8 is integrally formed by one plate-shaped member. As a result, for example, as compared with a case where the conductor is formed of a plurality of plate-shaped members connected by welding or the like, the distribution of the thermal expansion coefficient of the conductor 8 becomes uniform, and thus the reliability of the conductor is improved. In addition, for example, as compared with a case where the conductor is formed of a plurality of plate-shaped members connected by welding or the like, the distribution of the impedance of the conductor 8 becomes uniform, and thus noise can be more efficiently reduced.

The surface of the protruding portion 82 is plated. This improves reliability of electrical connection of the protruding portion 82 to the ground electrode 32 of the mating connector 3.

The electric wires 51 and 52 are a plurality of electric wires of a flexible flat cable (first cable 5), and the electric wires 61 and 62 are a plurality of electric wires of a flexible flat cable (second cable 6). This makes is possible to reduce noise of the plurality of electric wires of the flexible flat cable.

According to the connection structure 1, noise reduction can be realized as described above. In addition, since the protruding portion 82 is in contact with the ground electrode 32 of the mating connector 3 in an elastically deformed state, the protruding portion 82 can be certainly brought into contact with the ground electrode 32.

The substrate 31 of the mating connector 3 includes the protruding surface 31b that protrudes from the main surface 31a and abuts on the ferrule 4 of the electrical connector 2. This makes it possible to certainly fix the ferrule 4 to the mating connector 3 while certainly bringing the protruding portion 82 into contact with the ground electrode 32 of the mating connector 3.

### Modification

Although one embodiment of the present disclosure has been described above, the present disclosure is not limited to the above-described embodiment.

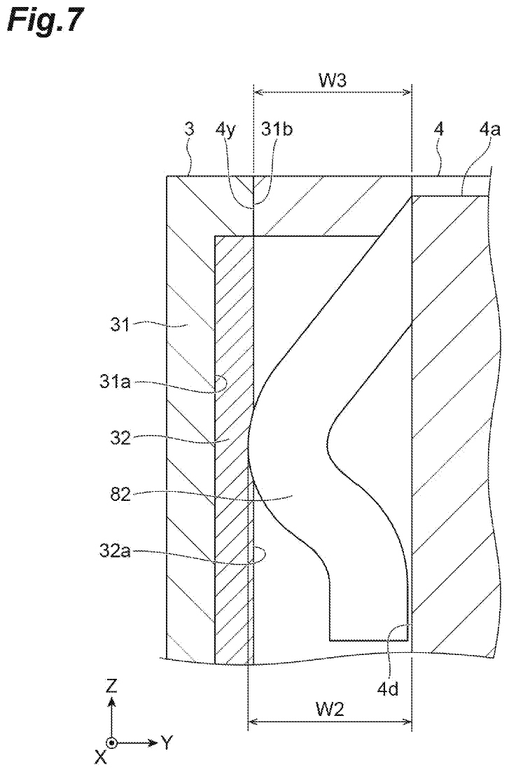

FIG. 7 is a sectional view of a connection structure according to a modification. As illustrated in FIG. 7, the ferrule 4 may further include an abutment surface 4y protruding from the front-end surface 4d in the Y-axis direction. The abutment surface 4y is a flat surface intersecting the Y-axis direction. The abutment surface 4y faces the same direction as the front-end surface 4d. The abutment surface 4y faces the substrate 31 of the mating connector 3. The abutment surface 4y abuts on the protruding surface 31b of the mating connector 3. The abutment surface 4y is located between the tip of the protruding portion 82 and the front-end surface 4d in the Y-axis direction. That is, a distance W3 between the abutment surface 4y and the front-end surface 4d in the Y-axis direction is smaller than the natural length W2 of the protruding portion 82 in the Y-axis direction.

The abutment surface 4y of the electrical connector 2 and the protruding surface 31b of the mating connector 3 abut on with each other. When the abutment surface 4y and the protruding surface 31b abut on each other, the protruding portion 82 comes into contact with the surface 32a of the ground electrode 32 in an elastically deformed state. This causes the conductor 8 of the electrical connector 2 to be electrically connected to the ground electrode 32 of the mating connector 3. In such a case as well, the ferrule 4 can be certainly fixed to the mating connector 3 while certainly bringing the protruding portion 82 into contact with the ground electrode 32 of the mating connector 3.

In the embodiment, an example in which the protruding portion 82 is formed in each of the first body region 81a, the second body region 81b, and the third body region 81c of the body portion 81 is described, but the protruding portion 82 does not have to be formed in all of the first body region 81a, the second body region 81b, and the third body region 81c. The plurality of protruding portions 82 do not have to be uniformly distributed around the insertion holes 4f and 4g when viewed from the Y-axis direction. The conductor 8 may include at least one protruding portion 82.

In the embodiment, an example in which one protruding portion 82 includes the first elastic body 82a and the second elastic body 82b is described, but one protruding portion 82 does not have to include both the first elastic body 82a and the second elastic body 82b.

What is claimed is:

1. An electrical connector comprising:
a ferrule including a front-end surface and a plurality of insertion holes extending along a first direction intersecting the front-end surface, the plurality of insertion holes being open in the front-end surface;
a plurality of electric wires disposed in the plurality of insertion holes; and
a conductor provided on the ferrule, wherein
the ferrule includes a groove formed at least between a pair of insertion holes adjacent to each other among the plurality of insertion holes, and
the conductor includes a body portion disposed in the groove and a protruding portion protruding from the front-end surface in the first direction, the protruding portion being elastically deformable in the first direction.

2. The electrical connector according to claim 1, wherein
the plurality of insertion holes are constituted by a first insertion hole array arranged along a second direction when viewed from the first direction and a second insertion hole array located adjacent to the first insertion hole array in a third direction intersecting the second direction when viewed from the first direction and arranged along the second direction,
the groove includes a first groove region located between the first insertion hole array and the second insertion hole array and extending along the second direction when viewed from the first direction, a second groove region located at least between a pair of insertion holes adjacent to each other in the first insertion hole array, and a third groove region located at least between a pair of insertion holes adjacent to each other in the second insertion hole array,
the body portion includes a first body region disposed in the first groove region, a second body region disposed in the second groove region, and a third body region disposed in the third groove region, and
the protruding portion protrudes from each of the first body region, the second body region, and the third body region.

3. The electrical connector according to claim 2, wherein
each of the first body region, the second body region and the third body region has a plate shape,
both ends of the first body region in the first direction reach a surface of the ferrule, both ends of the first body region in the second direction reach both ends of the first insertion hole array in the second direction and both ends of the second insertion hole array in the second direction,
a distal end of the second body region in the first direction reaches the front-end surface of the ferrule, a distal end of the second body region in the third direction reaches a surface of the ferrule, and
a distal end of the third body region in the first direction reaches the front-end surface of the ferrule, a distal end of the third body region in the third direction reaches a surface of the ferrule.

4. The electrical connector according to claim 2, wherein
the protruding portion is uniformly distributed when viewed from the first direction.

5. The electrical connector according to claim 1, wherein
the protruding portion includes a first elastic body protruding from the body portion and a second elastic body protruding from the body portion, and
the first elastic body and the second elastic body are disposed to cross each other.

6. The electrical connector according to claim 5, wherein
each of the first elastic body and the second elastic body is convexly curved.

7. The electrical connector according to claim 1, wherein the conductor is integrally formed by one plate-shaped member.

8. The electrical connector according to claim 1, wherein the material of the conductor is copper.

9. The electrical connector according to claim 1, wherein a surface of the protruding portion is plated.

10. The electrical connector according to claim 1, wherein the plurality of electric wires are a plurality of electric wires of a flexible flat cable.

11. A connection structure comprising:
the electrical connector according to claim 1; and
a mating connector including a substrate and a ground electrode provided on a main surface of the substrate, wherein
the electrical connector is connected to the mating connector with the front-end surface facing the main surface, and
the protruding portion is in contact with the ground electrode in an elastically deformed state.

12. The connection structure according to claim 11, wherein the substrate includes a protruding surface protruding from the main surface and abutting on the ferrule of the electrical connector.

13. The connection structure according to claim 11, wherein
the ferrule further includes an abutment surface protruding from the front-end surface and abutting on the substrate of the mating connector, and
the abutment surface is located between a tip of the protruding portion and the front-end surface in the first direction.
